(19) United States
(12) Patent Application Publication
(10) Pub. No.: US 2007/0250244 A1
(43) Pub. Date: Oct. 25, 2007

(54) Method for controlling a rope transport installation comprising a speed regulating section, and installation for implementation of the method

(75) Inventor: Nicolas Revenant, Echirolles (FR)

Correspondence Address: OLIFF & BERRIDGE, PLC, P.O. BOX 19928, ALEXANDRIA, VA, 22320, US

(73) Assignee: POMAGALSKI SA., Fontaine (FR)

(21) Appl. No.: 11/785,230

(22) Filed: Apr. 16, 2007

(30) Foreign Application Priority Data
Apr. 25, 2006 (FR) 06 03679

(51) Int. Cl. G01C 23/00

(52) U.S. Cl. 701/96; 701/301; 340/903; 701/3

(57) ABSTRACT

The invention relates to a method for controlling an aerial ropeway transport installation comprising a speed regulating section, that consists in assigning an individual identification code to each vehicle and in associating a setpoint value representative of the required distance between the vehicle and the vehicle preceding same, on exit from a speed regulating section, with said identification code. The invention also relates to an installation for implementation of the method.

### BACKGROUND OF THE INVENTION

The invention relates to a method for controlling the distance separating a vehicle from the vehicle preceding same in the direction of running, on exit from a speed regulating section of a continuous running aerial ropeway transport installation.

The invention also relates to a continuous running aerial ropeway transport installation for implementation of the method, wherein the rope supports vehicles staggered at a predetermined distance and with a predetermined running rate, said installation having, in at least one loading/unloading terminal, a speed regulating section associated with speed regulating means comprising means for selective driving of the vehicles controlled by a control unit to control the distance separating a vehicle from the vehicle preceding same in the direction of running, on exit from a speed regulating section.

### STATE OF THE ART

The scope of the invention concerns all types of transport installations for moving vehicles by means of a carrier rope, for example chair lifts or gondola cars.

Controlling the distance separating a vehicle and the vehicle preceding same in the direction of running, on exit from a speed regulating section of a continuous running rope transport installation, is necessary in order to dispose the vehicles along the rope with a predetermined regulation. In known methods, whatever the type of transport installation involved, the running speed is chosen such that the vehicles present an equal time interval between them. This time interval is identical in the terminals and along the ropeway. As the running speed of the rope is considerably greater than the driving speed of the vehicles in the terminals, the vehicles are much closer to one another in the terminals than along the ropeway. The minimum distance between two vehicles is for example conditioned by the physical distance necessary between these two vehicles to prevent them from bumping into one another in the terminals, in particular when their running path presents curves. The vehicles bumping into one another would be hazardous for people outside the vehicles and uncomfortable for the users embarked on or in them.

For this purpose, it is known to provide a speed regulating section along the transfer circuit of at least one of the loading/unloading terminals, but which section imposes on exit therefrom a regular running speed of the vehicles regardless of their frequency of entry. This speed regulating section enables the inevitable staggers which occur during operation (different braking and acceleration conditions from one vehicle to the other, variable loading of the vehicles, variable climatic conditions, etc.) to be avoided.

But these known installations are not fully satisfactory. Generally, the control unit functions in one of two different operating modes. In a first mode called “stopgap” mode, the control unit controls the means for driving the vehicles along the speed regulating section in such a way as to reposition any vehicle that has deviated with respect to its theoretical position, so that it resumes its theoretical position. The second operating mode, automatically activated when the first mode is deactivated, performs positioning of a vehicle to the nearest position that the vehicles are theoretically supposed to occupy. In this way, with this second mode, a vehicle that is slightly behind is repositioned in its theoretical position. A vehicle that is excessively behind on the other hand is repositioned in the following theoretical position seen in the direction of movement.

In practice, it often happens that a vehicle is taken off the line, for example because of a technical problem, then constituting what is commonly called a gap. When the first operating mode is activated, the control unit controls the means for driving the vehicles in such a way as to advance the vehicle that follows the gap in order to reduce the space formed. This movement is then passed on by successive moving forward of the following vehicles. Subsequently and in infinite manner, any vehicle passing through the speed regulating section will be moved as far as possible forwards without the installation ever being able to find a globally homogeneous distribution of the vehicles. This is why the second operating mode is generally activated when a vehicle is removed from the line. But in this case, if a vehicle still on the line gets to lag excessively behind for any reason whatsoever, the control unit operates the driving means in such a way as to reposition said vehicle in the next theoretical position, seen in the direction of running, where another vehicle is already present. Control systems then cause a complete shutdown of the installation.

To sum up, management of a gap, for example generated after a vehicle has been removed from the line, is very tricky or even in fact impossible. When the first operating mode of the control unit is activated, the speed regulating means associated with the speed regulating section are in fact continually actuated each time a vehicle passes, which may result in rapid wear of said speed regulating means and a notable impairment of comfort for the users on board. Moreover, when the second operating mode of the control unit is activated, the complete installation is subject to pointless nuisance stoppages.

More generally, as the separation regulation imposed by the speed regulating section is chosen in such a way that the vehicles present an equal time interval between one another, modularity of positioning of the vehicles along the ropeway is nil. For example it is impossible to configure the installation in such a way as to have successive groups of vehicles, said groups being separated by long distances.

### OBJECT OF THE INVENTION

The object of the invention is to palliate the above shortcomings by proposing a method for controlling the distance separating a vehicle and the vehicle in front of it, on exit from a speed regulating section of a continuous running aerial ropeway transport installation, which method provides a greater freedom of positioning of the vehicles along the rope.

According to the invention, this object is achieved by the fact that it consists in assigning an individual identification code to each vehicle and in associating a setpoint value representative of the required distance for said vehicle with said identification code.

The method according to the invention therefore enables a setpoint value representative of the required distance between said vehicle and the preceding vehicle, seen in the direction of running, to be associated with each vehicle, on exit from the speed regulating section. The setpoint value is transmitted to the control unit before the vehicle enters the speed regulating section, which controls the means for driving the vehicles accordingly in conventional manner.

It can easily be understood that the control method according to the invention enables the vehicles to be staggered separating them with different predefined separating distances. The setpoint value associated with each vehicle by assigning the individual identification code thereto can be modified at any time, for example by modifying the assigned code or by modifying the setpoint value associated with the code.

The invention also relates to a continuous running aerial ropeway transport installation for implementation of the method according to the invention, wherein the rope supports vehicles staggered at a predetermined distance and with a predetermined running rate, said installation having, in at least one loading/unloading terminal, a speed regulating section associated with speed regulating means comprising means for selective driving of the vehicles controlled by a control unit to control the distance separating a vehicle from the vehicle preceding same in the direction of running, on exit from a speed regulating section. The transport installation is remarkable in that the speed regulating means comprise:
identification means installed on board each vehicle and integrating an individual identification code of the vehicle,
means for reading the identification code, disposed at the entry of said terminal and connected to the control unit,
   the speed regulating means associating a setpoint value representative of the required distance between the corresponding vehicle and the vehicle preceding same, on exit from the speed regulating section, with each identification code.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 is a schematic top view of a bottom terminal of an example of an aerial ropeway transport installation for which the control method according to the invention is implemented,

FIG. 2 is a second schematic view of the bottom terminal of FIG. 1, showing in detail the speed regulating means associated with the speed regulating section of FIG. 3,

FIG. 3 is a partial view of a run-through section of the bottom terminal of FIGS. 1 and 2 showing details of an example of the speed regulating section according to the invention.

### DESCRIPTION OF PARTICULAR EMBODIMENTS

In the figures, an aerial rope 10 of a transport installation of the chairlift type extends in a closed loop between two loading/unloading terminals, only the bottom one 11 whereof is represented, and passes in the terminals on bull-wheels 12, one whereof, the drive bull-wheel, drives the rope 10 continuously. The rope 10 supports chairs 13 coupled by detachable grips and staggered along the rope according to a predetermined combination. The transport installation can comprise other intermediate terminals located along the up-line 14 and the down-line 15 of the rope 10 for loading and/or unloading passengers onto and from the chairs 13.

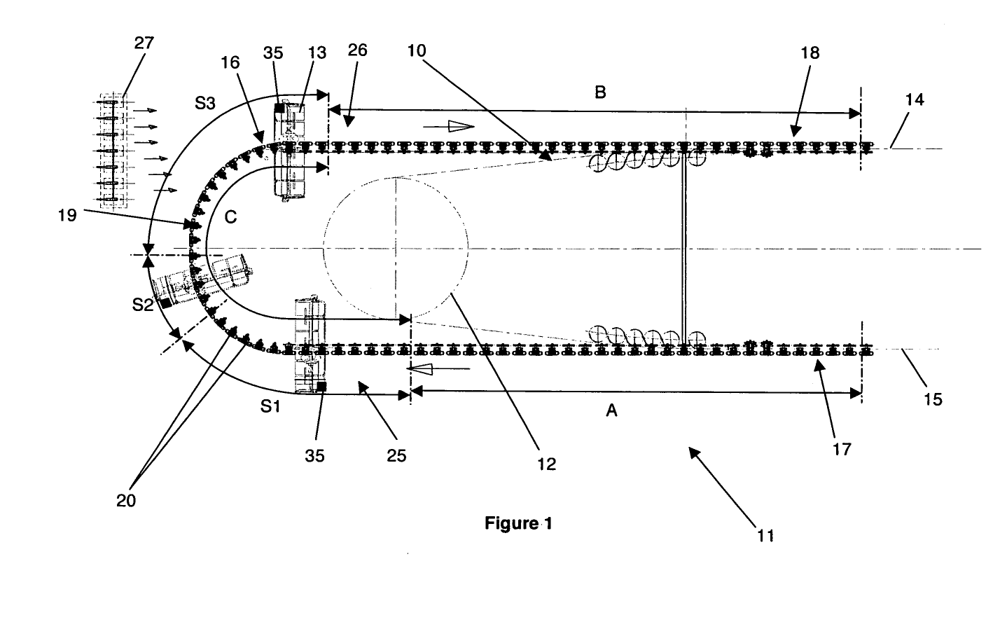

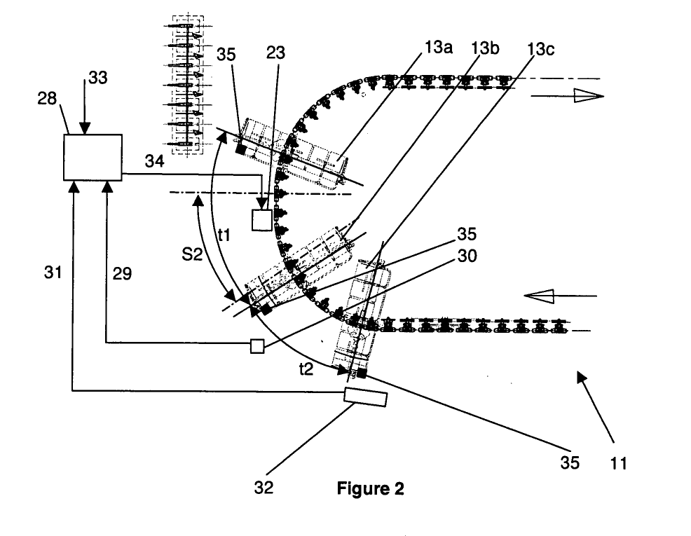

FIGS. 1 and 2 illustrate the bottom terminal 11. At the entry to the terminal 11, the chairs 13 are detached from the down-line 15 and run on a transfer circuit 16 at reduced speed in the terminal 11 until they reach the up-line 14. A slowing-down device 17 slows down the chairs 13 detached from the rope 10, whereas on exit a propelling device 18 re-accelerates them to a speed equal to that of the rope 10 to enable them to be recoupled without jerking. The slowing-down device 17 and propelling device 18 are both formed by a set of tire-clad wheels staggered along a section of the transfer circuit 16, respectively a slowing-down section A and a speeding-up section B, so as to operate by friction in conjunction with a friction track supported by the grips of the chairs 13. The wheels of the slowing-down device 17 and of the speeding-up device 18 are coupled by means of belts engaged on auxiliary pulleys fitted coaxially to the wheels. Each wheel is fixedly secured to two auxiliary pulleys, each respectively operating in conjunction with a belt, one of the belts engaging on one of the auxiliary pulleys of one of the adjacent wheels and the other of the belts operating in conjunction with one of the auxiliary pulleys of the other of the adjacent wheels. For driving, at least one of the wheels of each of the devices 17 and 18 can be connected by means of a belt to a driving power take-off branched-off from the rope 10 or the bull-wheel 12. Such devices are well-known and do not need to be described in any greater detail here.

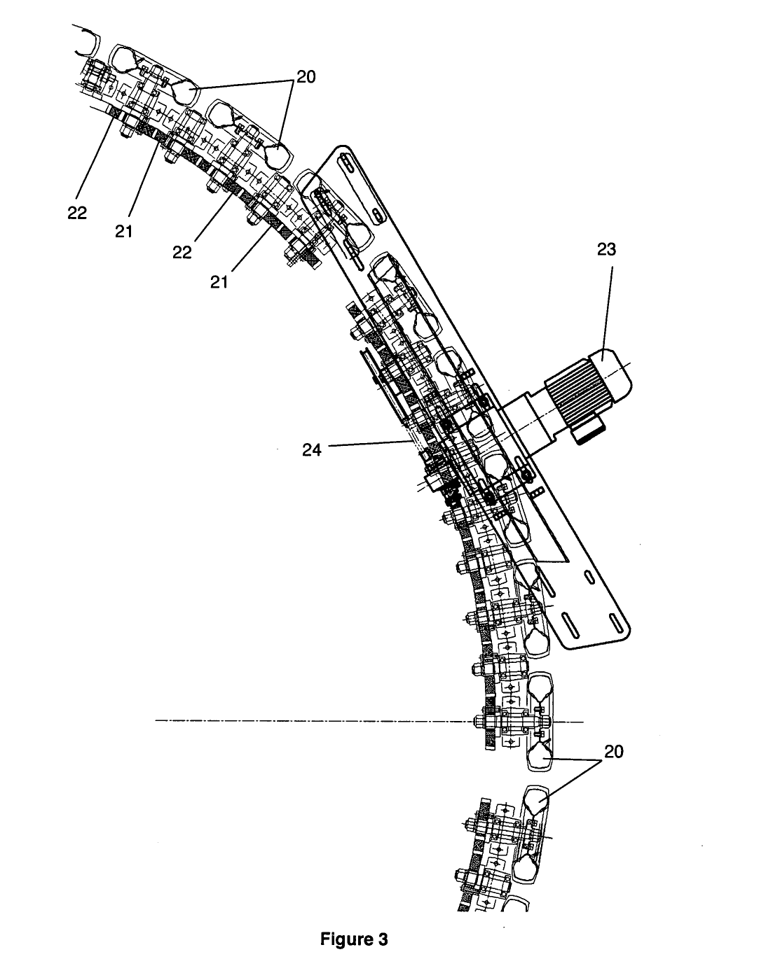

The slowing-down section A and speeding-up section B are connected by a run-through section C along which the chairs 13 run in continuous manner at reduced speed by means of a driving device 19 formed by sets of tire-clad wheels 20. The driving device 19 of the run-through section C is subdivided into three successive portions each delineating an elemental section S1, S2, S3 and able to have differential driving speeds. The wheels 20 of the semi-circular part of the run-through section C, within any one portion, are driven in synchronism with one another by idler pinions 21 (FIG. 3) intercalated between transmission pinions 22 mounted coaxially with the wheels 20. The rest of the wheels 20 of the run-through section C, in the straight portion of either section S1 or S3, are driven together in the same way as the wheels of the slowing-down device 17 and speeding-up device 18. The portion which delineates the section S2 is comprised of five wheels 20 and is separated from the other two portions by removal of an idler pinion 21. One of the wheels 20 of the portion delineating the section S1 is driven in rotation by one of the wheels of the slowing-down section A. In like manner, one of the wheels 20 of the portion delineating the section S3 is driven in rotation by one of the wheels of the speeding-up section B. To drive the five wheels 20 of the portion delineating the section S2, a variable-speed motor 23 (FIG. 4) drives a transmission belt 24 stretched between two pulleys one whereof is mounted coaxially with one of the idler pinions 21.

In the bottom loading/unloading terminal 11, an unloading location 25 is arranged along the sections S1 and S2. A loading location 26 on the chairs 13 is further arranged in coincident manner with the area covered by the chairs 13 along the section S3 to allow skiers entering via an access gate 27 to sit down on the chairs 13.

With reference to FIG. 2, the motor 23 that performs driving of the five wheels 20 of the portion delineating the section S2 is controlled by a control unit 28, for example an automatic controller, which can perform other functions, in particular that of control and monitoring of the whole installation. The control unit 28 receives a passage signal 29 representative of passing of the chairs 13, supplied by a presence sensor 30 arranged along the section S1 and providing a pulse each time a chair 13 passes. It also receives a selection signal 31 from a reading unit 32 provided upline from the section S2, arranged at a specific location between the slowing-down section A and the section S2. The presence sensor 30 can be integrated in the reading unit 32. The control unit 28 also receives a clock signal 33 emitted by a detector (not shown) operating in conjunction with the bull-wheel 12 and emitting pulses synchronized with the running of the rope 10. The output of the control unit 28 delivers a control signal 34 to the motor 23 so as to ensure suitable control of the motor 23 for a pre-determined regulation of the speed of the chairs 13 on exit from the section S2, in the manner which will be described further on. The section S2 is hereinafter called the speed regulating section S2.

Each chair 13 comprises a standard radiofrequency identification (RFID) tag 35 carried on-board the chair, in which tag an individual identification code of said chair 13 is stored. The tag 35 integrates an antenna tuned to a predetermined frequency, connected to a memory that contains the identification code. Fixing of the tag 35 can be performed by welding, sticking, heat transfer, overmoulding etc. In known manner, a carrier signal emitted by the reading unit 32 is received by the tag 35. This signal is used both as interrogation signal and as power supply for the tag 35. The latter returns a carrier signal modulated in amplitude or in frequency by the individual identification code. In practice, the selection signal 31 transmitted to the control unit 28 by the reading unit 32 is in turn representative of the individual identification code read.

In the alternative embodiment described, to be able to communicate by radiofrequency with the radiofrequency tag 35 fixedly secured to the chair 13, the reading unit 32 comprises an electronic processing unit, preferably with a microprocessor, connected to an antenna. The processing unit generates the selection signal 31.

The speed regulating section S2 according to the invention operates in the following manner: a chair 13 entering the bottom terminal 11 is detached from the rope 10 and runs along the transfer circuit 16 being propelled by the tire-clad wheels of the sections A, C, and then B. The wheels of the slowing-down section A slow the chair 13 down, whereas the following wheels 20 of the section S1 move it along the unloading location 25 until they reach the reading unit 32 arranged along the section S1. Passing of the chair 13 generates a selection signal 31 representative of the individual identification code integrated in the radiofrequency tag 35 carried by the chair. The selection signal 31 is transmitted to the control unit 28 which integrates a look-up table to associate a setpoint value with each identification code, which value is representative of the required distance between the corresponding chair 13 and the chair preceding same, on exit from the speed regulating section S2. The control unit 28 thus determines the theoretical distance that, on exit from the speed regulating section S2, should separate the chair 13 about to enter the speed regulating section S2 and the previous chair 13, seen in the direction of running. Knowing the setpoint value associated with the chair 13, the control unit 28 determines the driving speeds procured by the driving device 19 along the sections S1 and S2 so as to establish the theoretical time interval that should separate these two chairs 13 on exit from S2. The relationships for establishing the theoretical time intervals according to the driving speeds and the setpoint values are pre-recorded in the control unit 28. The driving speeds are determined by the control unit 28 from the clock signal 33.

The chair 13 then passes in front of the presence sensor 30 which sends a passage signal 29, generally in the form of a pulse, to the control unit 28 which incorporates a means for counting the time elapsed between two successive passage signals 29. The control unit 28 therefore establishes the actual time interval that separated said chair 13 and the previous chair 13 before said previous chair 13 passes through the speed regulating section S2.

By making a comparison between the theoretical time interval and the actual time interval measured, the control unit 28 is able to detect any deviation due to inevitable staggers liable to occur during operation (different braking and acceleration conditions from one chair 13 to the other, variable loading of the chairs 13, variable climatic conditions, etc.). The deviation is determined before the chair 13 reaches the speed regulating section S2.

Then, when the chair 13 runs through the speed regulating section S2, the control unit 28 uses a suitable control signal 34 to perform speed control of the variable speed motor 23 in such a way that the time the chair 13 takes to pass through the section is modulated to compensate for the deviation determined above.

Consequently, the speed regulating section S2 is equipped with speed regulating means formed by the control unit 28, the presence sensor 30, the reading unit 32, the variable speed motor 23, the detector delivering the clock signal 33, and the radiofrequency tags 35. According to the invention, the above speed regulating means enable an individual identification code to be assigned to each chair 13, and a setpoint value representative of the required distance, on exit from S2, between this chair 13 and the chair 13 preceding same, to be associated with said code.

This arrangement enables the distances between two successive chairs 13 to be modulated at will. For example, FIG. 2 illustrates that a first chair 13a is separated from a second chair 13b by a time interval t1 that is different from the time interval t2 between the second chair 13b and a following third chair 13c. Each of the time intervals t1 and t2 is expressed by a physical distance separating the chairs 13a, 13b, 13c which corresponds to the setpoint value respectively associated with the second chair 13b and with the third chair 13c. With suitable sets of setpoint values, it becomes possible to provide successive groups of chairs 13, said groups being separated by long distances.

To vary the setpoint value associated with a chair 13, the radiofrequency tags 35 of certain alternative embodiments of installations enabling the method according to the invention to implemented are removable. The on-board radiofrequency tag 35 simply has to be replaced to modify the identification code assigned to this chair 13. The selection signal 31 transmitted to the control unit 28 by the reading unit 32 is transformed accordingly. For example when a chair 13 is removed from the line, the setpoint value assigned to the following chair 13 will be doubled.

In other alternative embodiments of installations, the radiofrequency tags 35 are fixed. In this case, to be able to vary the setpoint value associated with a chair 13, it is possible to provide tags 35 whose code can be reprogrammed remotely. If this is not the case, the tables integrated in the control unit 28 for correspondence between the identification codes and the associated setpoint values will have to be modifiable.

In other alternative embodiments of installations, the selection signal 31 supplied to the control unit 28 by the reading unit 32 is directly representative of the setpoint value.

Other identification means integrating an individual identification code can be envisaged, such as for example tags presenting a bar code. The associated reading means will be modified accordingly, having recourse for example to a CCD sensor or a laser. The identification means can also be formed by a mechanical element, fixedly secured to the chair 13 or to its detachable grip, at least one of the dimensions whereof is representative of the corresponding identification code. In this case, any suitable reading means can be envisaged (mechanical, optical, electrical, etc.).

In most cases, the deviations from standard distribution of the chairs are slight and it suffices to equip one of the loading/unloading terminals 11 with a speed regulating section S2 equipped with speed regulating means according to the invention, preferably located at the arrival of the less used line 14, 15.

The control method according to the invention has been described herein in an application to a chairlift, but the latter can be considered as being a particular example of a transport installation enabling said method to be implemented. It is clear that the invention can be applied to other aerial ropeway transport installations such as for example cabin lifts, installations wherein the rope supports both the chairs and cars or cabins, and more generally all types of detachable aerial ropeways.

Finally, the invention is not limited to the described embodiment. It can be applied to different types of speed regulators, the implementation mode having to be adapted to the type of speed regulator used. The speed regulating section S2 can be arranged at any location on the transfer circuit 16. The run-through section C can be of any shape and can for example reproduce the teachings of French Patent applications 0501777 and 0304989 in order to increase the user throughput. The individual driving means of the portions delineating the sections S1 and S3 can consist of independent variable speed motors, for example controlled by the control unit 28. Mechanical driving of the vehicles can be performed by any other suitable means along the slowing-down section A, the speeding-up section B, and the portions delineated by the sections S1 and S3 of the driving device 19, for example by drive belts with external splines.

1. Method for controlling the distance separating a vehicle from the vehicle preceding same in the direction of running, on exit from a speed regulating section of a continuous running aerial ropeway transport installation, method consisting in assigning an individual identification code to each vehicle and in associating a setpoint value representative of the required distance for said vehicle with said identification code.

2. Method according to claim 1, wherein the individual identification assigned to a vehicle is stored in a radiofrequency tag installed on board said vehicle.

3. Continuous running aerial ropeway transport installation for implementation of the method according to claim 1, wherein the rope supports vehicles staggered at a predetermined distance and with a predetermined running rate, said installation having, in at least one loading/unloading terminal, a speed regulating section associated with speed regulating means comprising means for selective driving of the vehicles controlled by a control unit to control the distance separating a vehicle from the vehicle preceding same in the direction of running, on exit from a speed regulating section, said transport installation being characterized in that the speed regulating means comprise:
identification means installed on board each vehicle and integrating an individual identification code of the vehicle,
means for reading the identification code, disposed at the entry of said terminal and connected to the control unit,
the speed regulating means associating a setpoint value representative of the required distance between the corresponding vehicle and the vehicle preceding same, on exit from the speed regulating section, with each identification code.

4. Installation according to claim 3, wherein the control unit integrates a look-up table for correspondence between the identification codes and the associated setpoint values.

5. Installation according to claim 3, wherein, for each vehicle, the identification means are formed by a radiofrequency tag in which the corresponding identification code is stored.

6. Installation according to claim 3, wherein the identification means are formed by a mechanical element securedly fixed to the vehicle, at least one of dimensions whereof is representative of the corresponding identification code.

7. Installation according to claim 3, wherein the speed regulating means comprise a presence sensor arranged at a determined location along the path of the vehicles, upline from the speed regulating section, and able to transmit a passage signal representative of passage of the vehicles to the control unit.

8. Installation according to claim 7, wherein the control unit comprises means for counting the time elapsed between two successive passage signals.

9. Installation according to claim 3, wherein the control unit receives a clock signal synchronized with the rope and that, in accordance with said clock signal, the control unit modulates the time interval separating a vehicle and the vehicle preceding same, on exit from the speed regulating section, so as to correspond to the setpoint value associated with said vehicle.
